(19) United States
(12) Patent Application Publication
(10) Pub. No.: US 2020/0022386 A1
(43) Pub. Date: Jan. 23, 2020

(54) METHOD OF PREPARATION OF CANNABINOIDS CONTAINING BEVERAGES

(71) Applicants: PHARCON INC., Toronto (CA); RMW Pharma Consulting, Inc., Toronto (CA)

(72) Inventors: Joseph Schwarz, Toronto (CA); Michael Weisspapir, Toronto (CA)

(21) Appl. No.: 16/514,724

(22) Filed: Jul. 17, 2019

Related U.S. Application Data
(60) Provisional application No. 62/699,124, filed on Jul. 17, 2018.

(51) Int. Cl. A23L 2/38; A23L 33/105; A23L 33/115

(52) U.S. Cl. CPC A23L 2/38; A23L 33/115; A23L 33/105

(57) ABSTRACT

The present disclosure relates to a method of preparation of beverages, containing poorly water soluble cannabinoids, by two-stage dilution of the self-nanoemulsifying concentrate, and composition of the concentrate for preparation of such beverages.

### CROSS REFERENCE TO RELATED APPLICATION

This application claims benefit of U.S. Provisional Patent Application No. 62/699,124 filed on Jul. 17, 2018, which is incorporated herein by reference in its entirety to the full extent permitted by law.

### BACKGROUND

Biologically active components of Cannabis, either Cannabis indica (Marijuana) or Cannabis sativa (Hemp) such as cannabinoids (tetrahydrocannabinol THC, cannabidiol CBD, cannabivarin CBV, Cannabinol CBN and other, as well as presented in the plants terpenes, sesquiterpenes, terpenoids are widely used for medicinal, recreational, scientific and investigational practices. Low water solubility and poor bioavailability requires development of better absorbable products, containing cannabinoids and terpenes extracted from cannabis.

Beverages loaded with cannabis components may be useful for enhanced bioavailability, improved efficacy and better patient compliance.

U.S. Patent Publication No. 2018/0020699A1 describes CBD-containing liquid formulations prepared by dilution of concentrated solution of CBD in polysorbate with water. Obtained micellar solution of CBD demonstrated enhanced bioavailability. However, physical stability of the preparation is questionable due to huge oversaturation which caused precipitation of the water insoluble components during storage.

U.S. Pat. No. 9,743,680 B2 describes the use of microemulsions for addition to beverages biologically active components such as lipid soluble vitamins, antioxidants, colorants and flavors. Such approach can be used for incorporation of cannabinoids, but such formulation would comprise very high level of polyglycerol esters of fatty acids, providing unpleasant fatty taste to beverages.

U.S. Pat. No. 9,095,555 B2 teaches stable suspensions of different cannabinoids in liposomal formulations, stabilized by alginates. The preparation of these formulations requires the use of specialized equipment and the elimination of organic solvent during the process. The liposomal products are prone to aggregation and cannot be used for preparation of transparent beverages.

U.S. Pat. No. 6,383,513 B1 describes a method of preparation of biphasic systems (oil-in-water emulsions) by high pressure homogenization using lecithin as an emulsifier.

U.S. Patent Publication No. 2016/0193146A1 teaches the combination of cannabis oil and soluble starches such as maltodextrins. Cannabis oil absorbed on the polysaccharide can be used for preparation of beverages, but the formed emulsion is coarse and unstable. Accordingly, this approach can be used mainly for immediately consumed products.

WO 2017180953A1 describes cannabis extracts absorbed on sugar (sucrose) based sweeteners or elixirs containing such sweeteners and stabilized with cyclodextrins, polysaccharide gums and lecithin. Due to low absorption capacity of crystalline sugars, the loading of such formulations is relatively low.

U.S. Patent Publication No. 20170266127 describes a dry effervescent preparation which may form an emulsion when added to a targeted amount of water. Stability of the emulsion is not established, and CBD loading is low.

EU Patent Publication No. 3 290 026 Al “Method for Solubilizing Poorly Water-Soluble Dietary Supplements and Pharmaceutically Active Agents” describes the use of combination of large quantities of phospholipids with addition of mono- and triglycerides, fatty acids, alcohol and surfactants for incorporation of hydrophobic biologically active compounds. The formed compositions have good solubilization properties but require extended heating to reach full solubilization.

The brochure entitled “Art and Science of Cannabis Beverages” describes the use of high energy sonication equipment for preparation of cannabis oil emulsions and nanoemulsions. (The brochure can be accessed at: http://leherbe.com/knowledge-center/experiment/emulsification.)

Due to low bioavailability and poor absorption of cannabinoids, there is an unmet need in the art for a convenient preparation method of beverages containing effective amounts of biologically active components of cannabis which have adequate customer compliance. The present invention satisfies this need.

### SUMMARY

The invention describes preparation of stable monodisperse oil-in-water emulsions, where biologically active components completely dissolved in the oil phase and said nanosized droplets are practically invisible, and self-nanoemulsifying concentrates compositions, suitable for preparation of such beverages.

### BRIEF DESCRIPTION OF THE DRAWINGS

FIG. 1 presents particle size distribution resulted after a single step dilution of the self-nanoemulsifying concentrate with cold non-filtered non-degassed beer in ratio of concentrate to beverage 1:100.

FIG. 2 presents particle size distribution resulted after a single step dilution of the self-nanoemulsifying concentrate with non-carbonated non-filtered apple juice in a of concentrate to beverage ratio 1:200.

FIG. 3 presents particle size distribution resulted after a single step dilution of the self-nanoemulsifying concentrate with non-degassed non-filtered beer at room temperature in a ratio of concentrate to beverage 1:100.

FIG. 4. presents particle size distribution resulted after a first step dilution of the self-nanoemulsifying concentrate with a filtered (0.45 mcm nylon membrane with glass prefilter) non-carbonated apple juice at room temperature in a ratio of concentrate to beverage 1:4.

FIG. 5 presents particle size distribution resulted after a first step dilution of the self-nanoemulsifying concentrate with a warm (about 45° C.) filtered apple juice in a ratio of concentrate to beverage 1:8.

FIG. 6 presents particle size distribution resulted after two stages dilution of the self-nanoemulsifying concentrate with apple juice; first stage—dilution with a warm (about 40° C.) filtered apple juice in a ratio of concentrate to beverage 1:8, second stage—further dilution of the obtained mixture with a non-filtered apple juice at room temperature in a ratio 1:100 (final ratio of 1:800).

FIG. 7 presents particle size distribution resulted after two stages dilution of the self-nanoemulsifying concentrate with beer; first stage—dilution with a warm (about 45° C.) filtered degassed beer in a ratio of concentrate to beverage 1:10, second stage—further dilution of the obtained mixture with a cold (+5° C.) beer at room temperature in a ratio 1:60 (final ratio of 1:600).

FIG. 8 presents particle size distribution resulted after two stages dilution of the self-nanoemulsifying concentrate with beer; first stage—dilution with a warm (about 45° C.) filtered degassed beer in a ratio of concentrate to beverage 1:7, second stage—further dilution of the obtained mixture with a non-filtered beer at room temperature in a ratio 1:60 (final ratio of 1:320).

### DETAILED DESCRIPTION

While the present disclosure is capable of being embodied in various forms, the description below of several embodiments is made with the understanding that the present disclosure is to be considered as an exemplification of the claimed subject matter, and is not intended to limit the appended claims to the specific embodiments illustrated and/or described, and should not be construed to limit the scope or breadth of the present disclosure. The headings used throughout this disclosure are provided for convenience only and are not to be construed to limit the claims in any way. Embodiments illustrated under any heading may be combined with embodiments illustrated under any other heading.

Cannabinoids have extremely low water solubility and relatively high solubility in oils and polar organic solvents such as ethanol and propylene glycol. Micro- and nanoemulsions or liposomal formulations where cannabinoids incorporated into lipid phase of the colloidal dispersion can be efficiently used for preparation of cannabis loaded products. Nevertheless, for preparation of beverages with high content of biologically active cannabis components may be complicated since solubility in the oil phase may not be high enough to provide the desired concentration of cannabinoids in the prepared beverage while keeping the product stable and palatable. Additionally, terpenes presented in extract of cannabis, visibly improve solubility of cannabinoids while pure CBD, THC or other cannabinoids have much lower solubility. For example, solubility of CBD can reach 25-36 mg/ml at room temperature while 70% extract of Cannabis can be easily dissolved in ethanol in much higher concentration reaching concentrations of THC and CBD up to 70-100 mg/ml or higher. However, since cannabis terpenes are often associated with acrid and unpleasant taste and flavor, it is preferable to use purified cannabinoids with a potency (purity) of 90-100%.

It was unexpectedly found that pure cannabinoids have excellent solubility in physiologically acceptable aromatic compounds such as anisole, anethole, esters of benzoic or salicylic acids, tocopherols, tocotrienols and derivatives thereof. Moreover, such aromatic compound can be used as a single component to form an oil phase or can be combined with another hydrophobic component, either aromatic or not. Different physiologically acceptable hydrophobic compounds such as mono-, di- and triglycerides, aliphatic and fatty acid esters, essential oils can be added to the oil phase, but it also can contain a single aromatic component only to provide desired solubilization of pure cannabinoids. Aromatic compounds used as a solubilizer for cannabinoids can comprise from 0 to 100% of the oil phase.

It is well known that incorporation of poorly absorbable hydrophobic compounds into nanoparticulate colloidal delivery system such as nanoemulsion can significantly improve bioavailability and absorption of such components. To obtain nanoemulsions different methods have been proposed: high pressure homogenization, ultrasonic dispersion, transmembrane emulsification, etc.

Existing methods of preparation of cannabinoids loaded beverages based on high pressure homogenization, ultrasonic dispersion, high shear homogenization, transmembrane emulsification and other known to a skilled in the art person require complex and expensive equipment, are time consuming and often cause serious oxidation of the active components due to high impact of temperature and applied force.

The most convenient and power efficient method for obtaining of loaded nanoemulsions is preparation of self-nanoemulsifying delivery systems (SNEDS) when properties of the used components allow to build such composition.

Self-nanoemulsifying delivery systems (SNEDS) are compositions containing hydrophobic compound, dissolved in an oil or mixture of oils, surfactant, co-surfactant and additionally solvent and/or co-solvent. After mixing with water-containing media, SNEDS spontaneously forms a nanoemulsion (usually oil-in-water type) with droplets smaller than 1000 nm. In order to reach improved absorption and bioavailability of incorporated hydrophobic poorly soluble compound, this compound must remain in the oil droplet in dissolved state.

Practically all proposed SNEDS formulations of cannabinoids have oil phase consisting of food oils, mainly mono-di or triglycerides, such as medium chain triglycerides (MCT oil, coconut oil), fish oil, soy oil, olive oil, acetylated mono-and diglycerides, etc. The food oils have excellent safety profile and can provide a reasonable solubility of cannabinoids. Nevertheless, the solubility of cannabinoids in these oils is usually not sufficient to provide high loading of beverages (e.g., 50-100 mg/ml). Moreover, pure crystalline cannabinoids have mediocre (25-36 mg/ml) solubility in ethyl alcohol, the most common water miscible solvent used in SNEDS for oral consumption. The presence of natural terpenes (beta-caryophillene, mircene) in cannabis extracts improve solubility of cannabinoids but negatively impacts the taste and flavor.

### I. DEFINITIONS

For convenience, before further description of the present teachings, certain terms employed in the specification, examples, and appended claims are collected here. These definitions should be read in light of the remainder of the disclosure and as understood by a person of ordinary skill in the art. Unless defined otherwise, all technical and scientific terms used herein have the same meaning as commonly understood by a person of ordinary skill in the art.

A. General Terms

The use of the terms “a,” “an” and “the” and similar references in the context of this disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., such as, preferred, preferably) provided herein, is intended merely to further illustrate the content of the disclosure and does not pose a limitation on the scope of the claims. No language in the specification should be construed as indicating any non-claimed element as essential to the practice of the present disclosure.

The phrase “and/or,” as used herein, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements).

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of,” or “exactly one of” “Consisting essentially of”, when used in the claims, shall have its ordinary meaning as used in the field of patent law.

As used herein, the phrase “at least one” in reference to a list of one or more elements should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, all transitional phrases such as “comprising,” “including,” “carrying,” “having,” “containing,” “involving,” “holding,” “associated,” “associated with,” and the like are to be understood to be open-ended, i.e. to mean including but not limited to.

The use of individual numerical values are stated as approximations as though the values were preceded by the word “about” or “approximately.” Similarly, the numerical values in the various ranges specified in this application, unless expressly indicated otherwise, are stated as approximations as though the minimum and maximum values within the stated ranges were both preceded by the word “about” or “approximately.” In this manner, variations above and below the stated ranges can be used to achieve substantially the same results as values within the ranges. As used herein, the terms “about” and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about” or “approximately” will serve to broaden a particular numerical value or range. Thus, as a general matter, “about” or “approximately” broaden the numerical value. Also, the disclosure of ranges is intended as a continuous range including every value between the minimum and maximum values plus the broadening of the range afforded by the use of the term “about” or “approximately.” Thus, recitation of ranges of values herein are merely intended to serve as a shorthand method of referring individually to each separate value falling within the range, unless otherwise indicated herein, and each separate value is incorporated into the specification as if it were individually recited herein.

The phrase “substantially pure” refers to a substance having total purity of greater than 90%, specifically greater than 95%, more specifically greater than 98%, and most specifically greater than 99%. For example, the phrase “substantially pure substance A” means substance A is at least 90% pure with respect to all impurities, specifically substance A is at least 95% pure with respect to all impurities, more specifically substance A is at least 98% pure with respect to all impurities, and most specifically substance A is at least 99% pure with respect to all impurities.

A “subject” or a “patient” refers to any mammal (e.g., a human), such as a mammal that may be susceptible to a disease or disorder. Examples include a human, a non-human primate,a cow, a horse, a pig, a sheep, a goat, a dog, a cat, or a rodent such as a mouse, a rat, a hamster, or a guinea pig. In various embodiments, a subject refers to one that has been or will be the object of treatment, observation, or experiment.

B. Terms Related to Compositions of the Present Disclosure

“Lipid” refers to a fatty or waxy organic compound that is readily soluble in nonpolar solvent (e.g. ether) but not in polar solvent (e.g water). Its major biological functions involve energy storage, structural component of cell membrane, and cell signaling. Examples of lipids are waxes, monoglycerides, diglycerides, triglycerides (edible oils, fats), fat-soluble vitamins, sterols, cholesterol, and phospholipids.

A “surfactant” refers to an organic compound that contains both a hydrophobic group and a hydrophilic group. The hydrophilic group is often referred to as the head and the hydrophobic group as the tail. A surfactant will adsorb at interfaces between hydrophilic compositions, such as oil, and hydrophilic compositions, such as water, wherein the hydrophilic head will extend into the water and the hydrophobic tail will extend into the oil.

The phrase “therapeutically effective amount” as used herein means that amount of therapeutic effective agent that is effective for producing a desired therapeutic effect. Accordingly, a therapeutically effective amount treats or prevents a disease or a disorder, ameliorates at least one sign or symptom of the disorder, e.g., lowers a diabetic patient's glucose level.

The term “bioavailable” is art-recognized and refers to a form of the subject disclosure that allows for it, or a portion of the amount administered, to be absorbed by, incorporated to, or otherwise physiologically available to a subject or patient to whom it is administered.

### II. THE CANNABINOID COMPOSITION

In one embodiment, an alcoholic or non-alcoholic carbonated or non-carbonated beverage, containing poorly water soluble cannabinoids is prepared by two-stage dilution of a self-nanoemulsifying concentrate to form a cannabinoid composition.

In various embodiments, the cannabinoid composition comprises: (a) a cannabis component selected from the group consisting of cannabinoids, cannabis extract, individual biologically active components of cannabis and mixture thereof, (b) solubility enhancers/solubilizers, (c) lipid components, (d) surfactants, (e) solvents and mixtures thereof.

In another embodiment, the cannabinoid composition comprises at least one physiologically acceptable non-toxic aromatic compounds as efficient solubilizers for cannabinoids.

In yet another embodiment, the aromatic compound used as a solubilizer for cannabis component is selected from the group consisting of Anisole (methyl phenylether, methoxybenzene, major flavor component of anise), Anethole (1-(4-methoxyphenyl) propene, p-propenylanisole, major flavor component of fennel essential oil), benzyl acetate, ethyl benzoate, benzyl benzoate, alkyl salicylates are excellent solvents for THC, CBD, CBN, Cannabigerol (CBG), other cannabinoids and mixtures thereof. In another embodiment, the aromatic compound used as a solubilizer for the cannabis component is selected from the group consisting of tocols, tocotrienols, tocopherols, tocopherol esters and combination thereof.

In one embodiment, the aromatic compounds used as a solubilizer for the cannabis component comprise between about 0 and 100% by weight of the oil phase.

In various embodiments, the aromatic compounds are present in an amount between about 10% and about 90%, between about 20% and about 80%, between about 30% and about 70%, between about 40% and 60%, between about 10% and about 70%, between about 20% and about 60%, between about 30% and about 50%, between about 40% and about 45% by weight of the oil phase. In other embodiments, the aromatic compounds are present in about 0%, 0.50%, 0.75%, 0.10%, 1.25%, 1.50%, 1.75%, 2.0%, 2.25%, 2.50%, 2.75%, 3.00%, 3.25%, 3.50%, 3.75%, 4.00%, 4.25%, 4.50%, 4.75%, 5.0%, 5.25%, 5.50%, 5.75%, 6.00%, 6.25%, 6.50%, 6.75%, 7.00%, 7.25%, 7.50, 7.75%, 8.00%, 8.25%, 8.50%, 8.75%, 9.00%, 9.25%, 10.00%, 11.00%, 12.00%, 13.00%, 14.00%, 15.00%, 16.00%, 17.00%, 18.00%, 19.00%, 20.00%, 22.50%, 25.00%, 27.50%, 30%, 35%, 40%, 50%, 60%, 70%, 80%, 90% or about 100% by weight of the oil phase.

In one embodiment, the cannabinoid composition comprises: at least one cannabis component selected from the group consisting of cannabinoids, cannabis extract, individual biologically active components of cannabis and mixture thereof, solubility enhancers/solubilizers, lipid components, surfactants, solvents and mixtures thereof.

In various embodiments, the cannabis component is present in an amount between about 0.10% and about 90%, between about 0.2% and about 85%, between about 0.5% and about 80%, between about 1.0% and 75%, between about 10% and about 70%, between about 20% and about 60%, between about 30% and about 50%, between about 40% and about 45% by weight of the cannabinoid composition. In other embodiments, the cannabis component is about 0.10%, 0.50%, 0.75%, 1.00%, 1.25%, 1.50%, 1.75%, 2.0%, 2.25%, 2.50%, 2.75%, 3.00%, 3.25%, 3.4%, 3.50%, 3.75%, 4.00%, 4.10%, 4.20%, 4.30%, 4.40%, 4.50%, 4.60%, 4.70%, 4.80%, 5.0%, 5.20%, 5.3%, 5.50%, 5.75%, 6.00%, 6.25%, 6.50%, 6.75%, 7.00%, 7.1%, 7.2%, 7.25%, 7.50, 7.75%, 8.00%, 8.25%, 8.50%, 8.8%, 8.9%, 9.00%, 9.25%, 10.00%, 10.1%, 10.2%, 10.3%, 11.00%, 12.00%, 13.00%, 14.00%, 15.00%, 16.00%, 17.00%, 18.00%, 19.00%, 20.00%, 22.50%, 25.00%, 27.50%, 30%, 35%, 40%, 50%, 60%, 70%, 80%, or 90% by weight of the cannabinoid composition.

In one embodiment, the final concentration of cannabinoid in the cannabinoid composition after dilution varied from about 0.005 mg/ml to about 0.1 mg/ml, about 0.001 mg/ml to about 1 mg/ml, about 0.002 mg/ml to about 0.9 mg/ml, about 0.003 mg/ml to about 0.8 mg/ml, about 0.004 mg/ml to about 0.7 mg/ml, about 0.005 mg/ml to about 0.6 mg/ml, about 0.006 mg/ml to about 0.5 mg/ml, about 0.007 mg/ml to about 0.4 mg/ml, about 0.008 mg/ml to about 0.3 mg/ml, or about 0.009 mg/ml to about 0.2 mg/ml.

In yet another embodiment, the final concentration of cannabinoid in the cannabinoid composition after dilution is about 0.001 mg/ml, about 0.002 mg/ml, about 0.003 mg/ml, about 0.004 mg/ml, about 0.005 mg/ml, about 0.006 mg/ml, about 0.007 mg/ml, 0.008 mg/ml, about 0.009 mg/ml, about 0.01 mg/ml, about 0.01 mg/ml, about 0.02 mg/ml, about 0.03 mg/ml, about 0.04 mg/ml, about 0.05 mg/ml, about 0.06 mg/ml, about 0.07 mg/ml, 0.08 mg/ml, about 0.09 mg/ml, about 0.1 mg/ml, about 0.15 mg/ml, about 0.2 mg/ml, about 0.25 mg/ml, about 0.3 mg/ml, about 0.35 mg/ml, about 0.4 mg/ml, about 0.45 mg/ml, or 0.5 mg/ml.

In another embodiment, the cannabinoid is selected from the group consisting of: pure THC (Tetrahydrocannabinol), pure CBD (Cannabidiol), Extract containing 72% cannabinoids (36% THC, 35% CBD, 0.95% CBN), Extract containing 53% cannabinoids (22.6% THC, 29.8% CBD) and a mixture thereof.

In various embodiments, the solubility enhancer/solubilizer is present in an amount between about 0.10% and about 90%, between about 0.2% and about 85%, between about 0.5% and about 80%, between about 1.0% and 75%, between about 10% and about 70%, between about 20% and about 60%, between about 30% and about 50%, between about 40% and about 45% by weight of the cannabinoid composition. In other embodiments, the plant extract is about 0.10%, 0.50%, 0.75%, 1.00%, 1.25%, 1.50%, 1.75%, 2.0%, 2.25%, 2.50%, 2.75%, 3.00%, 3.25%, 3.50%, 3.75%, 4.00%, 4.25%, 4.50%, 4.75%, 5.0%, 5.25%, 5.50%, 5.75%, 6.00%, 6.25%, 6.50%, 6.75%, 7.00%, 7.25%, 7.50, 7.75%, 8.00%, 8.25%, 8.50%, 8.75%, 9.00%, 9.25%, 10.00%, 11.00%, 12.00%, 13.00%, 14.00%, 15.00%, 16.00%, 17.00%, 18.00%, 19.00%, 20.00%, 22.50%, 25.00%, 27.50%, 30%, 35%, 40%, 50%, 60%, 70%, 80%, or 90% by weight of the cannabinoid composition.

In yet another embodiment, the solubility enhancer/solubilizer is selected from the group consisting of: Anise seeds essential oil, Fennel essential oil, Caraway essential oil, Bay leaf essential oil, Dill essential oil, Hops essential oil, Peppermint oil, Anisole, Anethole, Benzyl acetate, Benzyl benzoate, Ethyl salicylate, D,L-alpha tocopherol, D-alpha tocopherol, D,L-alpha tocopherol acetate, Tocotrienol mix, Tocopherol mix and a mixture thereof.

In various embodiments, the lipid is present in an amount between about 0.01% and about 90%, between about 0.05% and about 85%, between about 0.1% and about 80%, between about 0.1% and 70%, between about 0.1% and about 60%, between about 0.1% and about 65%, between about 0.1% and about 50% by weight of the cannabinoid composition. In other embodiments, the lipid is about 0.10%, 0.50%, 0.75%, 1.00%, 1.25%, 1.50%, 1.75%, 2.0%, 2.25%, 2.50%, 2.75%, 3.00%, 3.25%, 3.50%, 3.75%, 4.00%, 4.25%, 4.50%, 4.75%, 5.0%, 5.25%, 5.50%, 5.75%, 6.00%, 6.25%, 6.50%, 6.75%, 7.00%, 7.25%, 7.50, 7.75%, 8.00%, 8.25%, 8.50%, 8.75%, 9.00%, 9.25%, 10.00%, 11.00%, 12.00%, 13.00%, 14.00%, 15.00%, 16.00%, 17.00%, 18.00%, 19.00%, 20.00%, 22.50%, 25.00%, 27.50%, 30%, 35%, 40%, 50%, 60%, 70%, 80%, or 90% by weight of the cannabinoid composition.

In one embodiment, the lipid component is selected from the group consisting of: Olive oil, Acetylated mono- diglycerides (Myvacet™), Medium chain triglycerides (Miglyol 812), Triethyl citrate, Capric/caprylic acid mono-diglycerides (Capmul MCM), Diethyladipate; Ethyl oleate and a mixture thereof.

In various embodiments, the cannabinoid composition comprises one or more surfactants. In some embodiments the surfactant is between about 0.10% and about 90%, between about 0.2% and about 85%, between about 0.5% and about 80%, between about 1.0% and 75%, between about 10% and about 70%, between about 20% and about 60%, between about 30% and about 50%, between about 40% and about 45% by weight of the cannabinoid composition. In other embodiments, the surfactant is about 0.10%, 0.50%, 0.75%, 1.00%, 1.25%, 1.50%, 1.75%, 2.0%, 2.25%, 2.50%, 2.75%, 3.00%, 3.25%, 3.50%, 3.75%, 4.00%, 4.25%, 4.50%, 4.75%, 5.0%, 5.25%, 5.50%, 5.75%, 6.00%, 6.25%, 6.50%, 6.75%, 7.00%, 7.25%, 7.50, 7.75%, 8.00%, 8.25%, 8.50%, 8.75%, 9.00%, 9.25%, 10.00%, 11.00%, 12.00%, 13.00%, 14.00%, 15.00%, 16.00%, 17.00%, 18.00%, 19.00%, 20.00%, 22.50%, 25.00%, 27.50%, 30%, 35%, 40%, 50%, 60%, 70%, 80%, or 90% by weight of the cannabinoid composition.

In another embodiment, the surfactant is selected from the group consisting of: Polysorbate 20, Polysorbate 40, Polysorbate 60, Polysorbate 80, Polysorbate 85, Sorbitan monooleate (Span 80), Sorbitan monostearate (Span 60), PEG-40 hydrogenated castor oil (Kolliphor RH-40), PEG-15 hydroxystearic acid (Solutol HS-15), d-α-Tocopheryl polyethylene glycol 1000 succinate (TPGS), PEG stearates, polyglyceryl oleate, polyglyceryl laurate, Sucrose stearate, Sucrose distearate, Saponins (Quinaja), Sodium deoxycholate, Sodium dioctylsulfosuccinate, Glycyrrhizic acid ammonium salt, Phospholipids, Soy and Sunflower lecithins (Phospholipons, Alcolecs), Distearoyl phosphatidyl choline, Lysolecithin, Phosphatidyl serine, Distearoyl phosphatidyl glycerol sodium salt, Phosphatidic acid ammonium salt and a mixture thereof.

In various embodiments, the solvent is present in an amount between 0.1% and 40% by weight of the cannabinoid composition.

In another embodiments, the solvent is present in an amount of about 0.10%, 0.50%, 0.75%, 1.00%, 1.25%, 1.50%, 1.75%, 2.0%, 2.25%, 2.50%, 2.75%, 3.00%, 3.25%, 3.50%, 3.75%, 4.00%, 4.25%, 4.50%, 4.75%, 5.0%, 5.25%, 5.50%, 5.75%, 6.00%, 6.25%, 6.50%, 6.75%, 7.00%, 7.25%, 7.50, 7.75%, 8.00%, 8.25%, 8.50%, 8.75%, 9.00%, 9.25%, 10.00%, 11.00%, 12.00%, 13.00%, 14.00%, 15.00%, 16.00%, 17.00%, 18.00%, 19.00%, 20.00%, 22.50%, 25.00%, 27.50%, 30%, 35%, or 40% by weight of the cannabinoid composition.

In yet another embodiment, the solvent is selected from the group consisting of: Ethyl alcohol, Diethylene glycol monoethyl ether (Transcutol® HP) and a mixture thereof.

In another embodiment, the cannabinoid composition can additionally contain physiologically acceptable additives, antioxidants, sweeteners, flavors, colorants, preservatives, and taste-masking components.

In one embodiment, the cannabinoid composition is a non-carbonated, carbonated, non-alcoholic, or alcoholic beverage.

In various embodiments, the non-carbonated beverage is selected from the group consisting of: water; apple juice; beet juice; orange juice; grape juice; grapefruit juice; mango juice, milk, whey, coconut water; coconut milk, tea, herbal teas, coffee, chicory, mate, or any other non-carbonated beverage.

In another embodiment, the carbonated alcoholic and non-alcoholic beverage is selected from the group consisting of: beer, non-alcoholic beer; cider, sparkling wine, champagne, soda water, tonic water; energetic drinks, coke, sprite, root beer, or any other carbonated alcoholic and non-alcoholic beverage.

In yet another embodiment, the alcoholic is selected from the group consisting of: wines, vodka, whiskey, rum, gin, tequila, mezcal, raicilla, arak, rakia, brandy, cognac, liqueurs, mixed alcoholic beverages, cocktails, or any other alcoholic beverage.

### III. THE METHOD OF FORMING THE CANNABINOID COMPOSITION

In one embodiment, the order of mixing of SNEDS composition containing cannabinoids, oil phase and surfactants along with cosurfactants and solvents with water or a beverage is important for formation of a stable and uniform oil-in-water nanoemulsion.

In another embodiment, a cannabinoid composition comprising at least one cannabis component is prepared using the steps of:

(a) diluting a SNEDS concentrate of at least one cannabis component with a beverage-containing liquid in relatively low ratio (e.g., from 1:1 to 1:100, preferably from 1:2 to 1:30) to form a pre-diluted mixture, and

(b) combining the pre-diluted mixture with the desired amount of a beverage thus forming the cannabinoid composition with an anticipated concentration of the cannabis component.

In yet another embodiment, composition comprising cannabinoids is prepared using the steps of:

(a) diluting a SNEDS concentrate of a cannabinoid with a beverage-containing liquid in relatively low ratio (e.g., from 1:1 to 1:100, preferably from 1:2 to 1:30) to form a pre-diluted mixture, and

(b) combining the pre-diluted mixture with the desired amount of a beverage thus forming the anticipated concentration of cannabinoid.

In one embodiment, step (a) of the dilution comprises adding a water-containing liquid to the SNEDS with stirring, and step (b) of combining the pre-diluted mixture with the beverage comprises adding the pre-diluted mixture to all amount of a beverage while mixing.

In another embodiment, an alcoholic or non-alcoholic carbonated or non-carbonated beverage comprising at least one cannabis component, wherein the method comprises the steps of:

(a) diluting a SNEDS concentrate of at least one cannabis component with a liquid in ratio of liquid to concentrate from about 1:1 to about 100:1 by volume to form a pre-diluted mixture, and

(b) combining the pre-diluted mixture with an amount of a beverage thus forming a cannabinoid composition.

In yet another embodiment, the pre-diluted mixture of step (a) comprises cannabis component to beverage-containing liquid in a ratio from about 1:1 to 1:100, 1:1 to 1:90, 1:1 to 1:80, 1:1 to 1:70, 1:1 to 1:60, 1:1 to 1:50, 1:1 to 1:40, 1:1 to 1:30, 1:1 to 1:20, or 1:1 to 1:10 by volume. In yet another embodiment, the pre-diluted mixture of step (a) comprises cannabis component to beverage, water or a water-containing liquid in a ratio of about, 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:35, 1:40, 1:45, 1:50, 1:55, 1:60, 1:65, 1:70, 1:75, 1:80, 1:85, 1:90, 1:95, 1:100, 1:200, 1:300, 1:400, 1:500, 1600, 1:700, 1:800, 1:900, or 1:1000 by volume.

In another embodiment, the pre-diluted mixture is combined with a beverage, water or a water-containing liquid in a ratio of the pre-diluted mixture to the beverage, water or a water-containing liquid from about 1:5 to about 1:1000 by volume. In one embodiment, the ratio of the pre-diluted mixture to the beverage, water or a water-containing liquid is about, 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:35, 1:40, 1:45, 1:50, 1:55, 1:60, 1:65, 1:70, 1:75, 1:80, 1:85, 1:90, 1:95, 1:100, 1:200, 1:300, 1:400, 1:500, 1600, 1:700, 1:800, 1:900, or 1:1000 by volume.

In yet another embodiment, the method of preparing the cannabinoid composition comprises degassing of the dilution liquid or beverage especially during the first stage of dilution. Dilution with a degassed media leads to more efficient emulsifying and better homogeneity of the formed nanoemulsion. In one embodiment, degassing can be reached by sonication, membrane filtration, boiling or purge with an inert gas, e.g., helium.

In another embodiment, the method of preparing the cannabinoid composition comprises filtrating of the beverage or water-containing liquid through microporous membrane filter with pores diameters from about 0.1 to about 5 mcm before the initial step of concentrate (SNEDS) dilution (step a). On one embodiment, the filtration improves particle size distribution of the formed nanoemulsion.

In yet another embodiment, the method of preparing the cannabinoid composition comprises combining the filtration with the degassing step.

In another embodiment, the dilution steps are carried out at temperatures from about 0° C. to about 100° C. In a one embodiment, the dilution steps are carried out at a temperature of about 0° C., 5° C., 10° C., 15° C., 20° C., 25° C., 30° C., 35° C., 40° C., 45° C., 50° C., 55° C., 60° C., 65° C., 70° C., 80° C., 85° C., 90° C., 95° C. or about 100° C.

In various embodiments, the dilution steps are followed by filtration through a membrane filter with pore size from about 0.1 to about 5.0 mcm. In another embodiment, the pore size of the membrane filter is about 0.1 mcm, 0.5 mcm, 1.0 mcm, 1.5 mcm, 2.0 mcm, 2.5 mcm, 3.0 mcm, 3.5 mcm, 4.0 mcm, 4.5 mcm, or about 5.0 mcm.

In one embodiment, the oil-in-water droplets have an average size of less than about 500 nm, 400 nm, 300 nm, 250 nm, 200 nm, 180 nm, 150 nm, 120 nm, 100 nm, 90 nm, 80 nm, 70 nm, 60 nm, 50 nm, 40 nm, 30 nm, 20 nm, 15 nm, 10 nm, 5 nm or 1 nm. In other embodiments, the oil-in-water droplets have an average size of about 1 nm, 5 nm, 10 nm, 20 nm, 30 nm, 40 nm, 50 nm, 60 nm, 70 nm, 80 nm, 90 nm, 100 nm, 120 nm, 150 nm, 180 nm, 200 nm, 250 nm or 300 nm. In further embodiments, the oil-in-water droplets have an average size of 1-500 nm, 1-400 nm, 1-300 nm, 1-250 nm, 1-200 nm, 1-150 nm, 1-100 nm, 1-75 nm, 1-50 nm, 5-500 nm, 5-400 nm, 5-300 nm, 5-200 nm, 5-150 nm, 5-100 nm, or 5-75 nm.

### IV. EXAMPLES

The following examples illustrate the features and scope of the present invention. These examples should not be considered as any limitations, but should be merely interpreted to teach beverages, containing poorly water soluble cannabinoids and preparation thereof.

The following examples are intended to illustrate various embodiments of the proposed invention and are not intended to be limiting of the invention definition in any way.

Pure crystalline cannabinoids may have limited solubility in self-nanoemulsifying compositions:

### Example 1

| | |
|---|---|
| Cannabidiol CBD (99.3%) | 50 mg |
| MCT oil (Miglyol 812) | 200 mg |
| Polysorbate 80 | 200 mg |
| Sorbitan monooleate | 50 mg |
| Ethyl alcohol | 500 mg |

Pure Cannabidiol (CBD) was mixed with Polysorbate 80 and Span-80, then MCT oil and ethanol were added. After sonication for 40 minutes significant part of CBD remains undissolved.

Similar results were observed for pure crystalline Tetrahydrocannabinol (THC)

### Example 2

| | |
|---|---|
| Tetrahydrocannabinol THC (99.7%) | 50 mg |
| Acetylated mono-diglycerides (Myvacet) | 200 mg |
| Kolliphor RH 40 | 160 mg |
| Kolliphor PS 60 | 40 mg |
| Soy lecithin (Phospholipon 85) | 50 mg |
| Ethyl alcohol | 500 mg |

At the same time extracts of cannabis, containing beside cannabinoids different terpenes, terpenoids and oil demonstrate complete solubilisation.

Addition of small amounts of D-alpha Tocopherol, usually used as antioxidant, does not improve the solubility

### Example 3

| | |
|---|---|
| Cannabidiol CBD (99.3%) | 50 mg |
| MCT oil (Miglyol 812) | 198 mg |
| D-alpha Tocopherol | 2 mg |
| Polysorbate 80 | 200 mg |
| Sorbitan monooleate | 50 mg |
| Ethyl alcohol | 500 mg |

Crystalline Cannabidiol (CBD) was mixed with Polysorbate 80 and Span-80, then MCT oil, D-alpha Tocopherol and ethanol were added. After sonication for 40 minutes significant part of CBD remains undissolved.

Replacement of significant part of lipid for a Tocopherol noticeably improved solubility of cannabinoid.

### Example 4

| | |
|---|---|
| Cannabidiol CBD (99.3%) | 50 mg |
| MCT oil (Miglyol 812) | 40 mg |
| D-alpha Tocopherol | 160 mg |
| TPGS | 225 mg |
| Kolliphor PS 60 | 50 mg |
| Soy lecithin (Phospholipon 85) | 75 mg |
| Ethyl alcohol | 450 mg |

Practically all CBD dissolved and remains dissolved at room temperature (2 hours shaking).

### Example 5

| | |
|---|---|
| Cannabidiol CBD (99.3%) | 50 mg |
| Acetylated mono-diglycerides (Myvacet 9-45K) | 100 mg |
| Anisole | 100 mg |
| TPGS | 180 mg |
| Kolliphor PS 60 | 70 mg |
| Soy lecithin (Phospholipon 85) | 80 mg |
| Ethyl alcohol | 420 mg |

### Example 6

| | |
|---|---|
| C. indica extract 72% cannabinoids | 70 mg |
| Acetylated mono-diglycerides (Myvacet 9-45K) | 200 mg |
| Kolliphor RH 40 | 160 mg |
| Kolliphor PS 60 | 40 mg |
| Soy lecithin (Phospholipon 85) | 50 mg |
| Ethyl alcohol | 480 mg |

Cannabis extract was mixed with surfactants; after addition of Myvacet and ethanol the mixture was sonicated. After sonication for 15 minutes clear solution was obtained.

Formulation without a solvent also showed complete solubilisation of the extract.

### Example 7

| | |
|---|---|
| C. indica extract 72% cannabinoids | 150 mg |
| Acetylated mono-diglycerides (Myvacet 9-45K) | 300 mg |
| Kolliphor RH 40 | 250 mg |
| Kolliphor PS 60 | 100 mg |
| Soy lecithin (Phosal 53 MCT) | 200 mg |

### Example 8

| | |
|---|---|
| C. indica extract 72% cannabinoids | 70 mg |
| D,L-alpha-Tocopherol | 80 mg |
| D-alpha Tocopherol acetate | 120 mg |
| TPGS | 110 mg |
| Solutol HS-15 | 90 mg |
| Soy lecithin (Phospholipon 85) | 50 mg |
| Ethyl alcohol | 480 mg |

### Example 9

| | |
|---|---|
| Cannabis extract 53% cannabinoids | 105 mg |
| D,L-alpha-Tocopherol | 30 mg |
| D-alpha Tocopherol acetate | 110 mg |
| MCT oil | 90 mg |
| TPGS | 140 mg |
| Kolliphor RH 40 | 60 mg |
| Soy lecithin (Phospholipon 80) | 80 mg |
| Ethyl alcohol | 400 mg |

### Example 10

| | |
|---|---|
| Cannabidiol CBD (99.3%) | 50 mg |
| Anethole | 40 mg |
| D-alpha Tocopherol acetate | 120 mg |
| TPGS | 100 mg |
| PEG 40 stearate | 110 mg |
| Sunflower lecithin (Alcolec H) | 50 mg |
| Ethyl alcohol | 480 mg |

### Example 11

| | |
|---|---|
| Cannabidiol CBD (99.3%) | 50 mg |
| Ethyl Salicylate | 50 mg |
| D-alpha Tocopherol | 100 mg |
| Capmul MCM | 60 mg |
| Polysorbate 20 | 150 mg |
| TPGS | 170 mg |
| Soy lecithin (Phosal 53 MCT) | 100 mg |
| Ethyl alcohol | 140 mg |
| Diethylene glycol monoethyl ether (Transcutol HP) | 180 mg |

### Example 12

| | |
|---|---|
| C. sativa extract 72% cannabinoids | 70 mg |
| Dill essential oil | 10 mg |
| Labrafil M1944CS | 60 mg |
| MCT oil | 60 mg |
| D-alpha Tocopherol acetate | 100 mg |
| TPGS | 140 mg |
| Sucrose monostearate | 50 mg |
| Ammonium glycyrrhizinate | 10 mg |
| Sodium deoxycholate | 5 mg |
| Ethyl alcohol | 475 mg |

### Example 13

| | |
|---|---|
| C. indica extract (contains 50 mg THC) | 175 mg |
| Caraway essential oil | 50 mg |
| d,l-alpha Tocopherol | 50 mg |
| MCT oil | 350 mg |
| D-alpha Tocopherol acetate | 100 mg |
| TPGS | 200 mg |
| Soy lecithin (Phospholipon 90) | 150 mg |
| Polysorbate 60 | 300 mg |
| Ethyl alcohol | 600 mg |

### Example 14

| | |
|---|---|
| Tetrahydrocannabinol THC (99.7%) | 50 mg |
| Anise seeds essential oil (93% trans-Anethol) | 48 mg |
| Butylated hydroxytoluene | 0.13 mg |
| Ascorbyl palmitate | 0.25 mg |
| D-alpha Tocopherol acetate | 120 mg |
| Myvacet 9-45K | 180 mg |
| TPGS | 150 mg |
| Polysorbate 20 | 220 mg |
| Soy lecithin (Phospholipon 80) | 120 mg |
| Ethyl alcohol | 580 mg |

### Example 15

### Mixing of the Concentrate with Liquids

The final concentration of CBD in beverages after dilution varied from about 1 to about 20 mg/200 ml (0.005-0.1 mg/ml)

Non-carbonated beverages: water; apple juice; beet juice; orange juice; grape juice; grapefruit juice; mango juice, milk, whey, coconut water; coconut milk, tea, herbal teas, coffee, chicory, mate, etc.

Carbonated alcoholic and non-alcoholic beverages: beer, non-alcoholic beer; cider, sparkling wine, champagne, soda water, tonic water; energetic drinks, coke, sprite, root beer, etc.

Alcoholic beverages: wines, vodka, whiskey, rum, gin, tequila, mezcal, raicilla, arak, rakia, brandy, cognac, liqueurs, mixed alcoholic beverages, cocktails, etc.

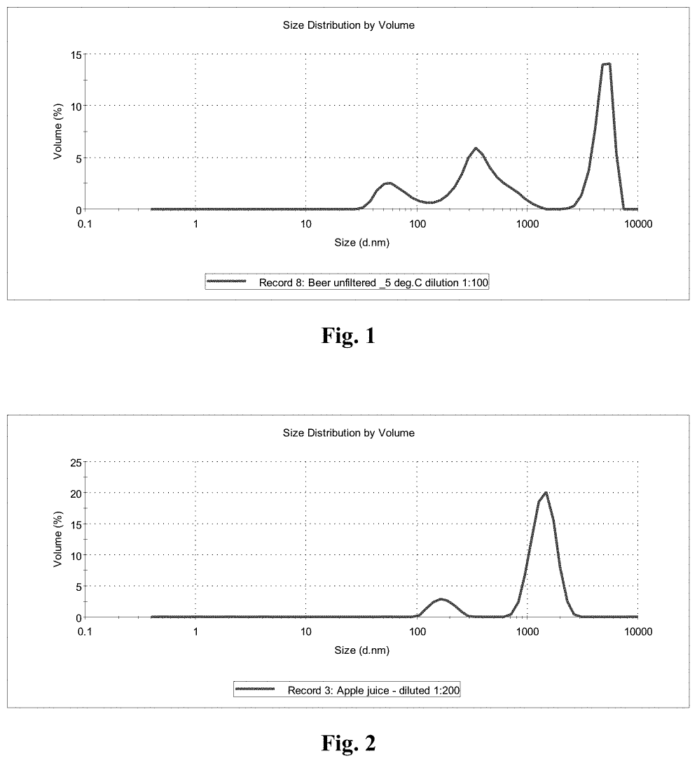

Mixing of the concentrate containing about 50 mg of pure CBD per 1 g of the preparation with refrigerated non-alcoholic beer at 5° C. in one step (ratio 1:100) lead to formation of visible cloudiness, turbidity and visible aggregates/particles (FIG. 1).

Mixing of the same concentrate with apple juice (1:200) also lead to formation of noticeable population of relatively large oil droplets (FIG. 2).

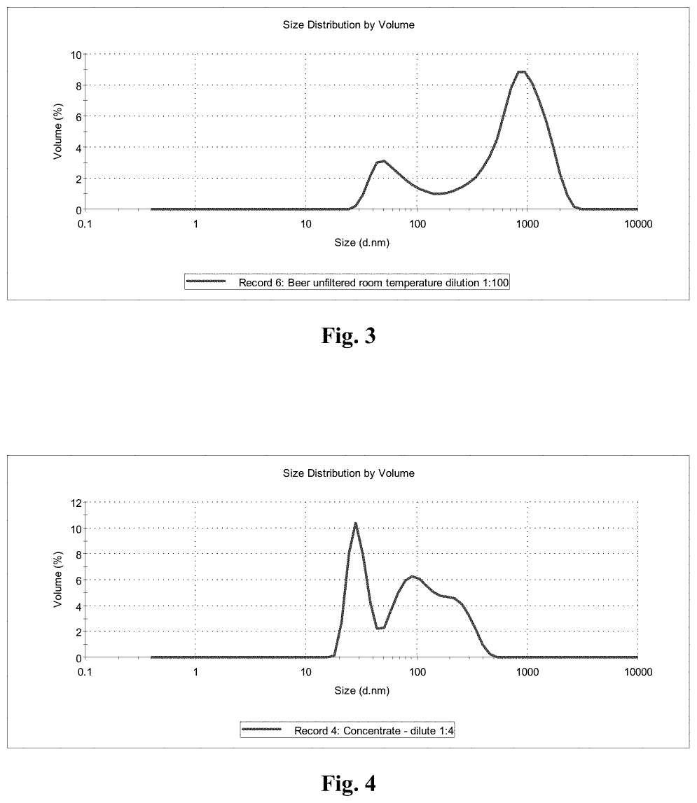

Dilution of the self-nanoemulsifying concentrate with unfiltered non-degassed beer at room temperature (˜22° C.) in 1:100 ratio also results in a dominant population of large oil droplets (FIG. 3).

Results of initial dilution of the self-emulsifying cannabinoid loaded concentrate with non-carbonated beverage (apple juice), filtered at room temperature through nylon filter 0.45 mcm in ratio 1:4 presented on FIG. 4. Formed emulsion is predominantly nanosized.

Dilution of the same concentrate with apple juice, filtered and diluted in a ratio 1:8 in a warm state (40-45° C.) leaded to a nanoemulsion with most of the oil droplets about 30 nm size (FIG. 5).

Two steps dilution allowed to prepare nanoemulsions with uniform size distribution.

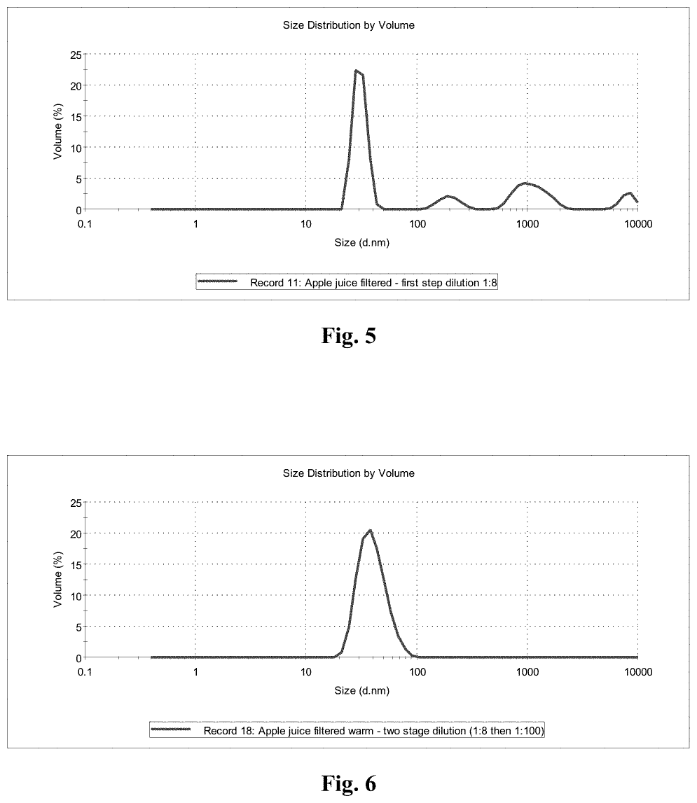

FIG. 6 presents particle size distribution resulted after two stages dilution of the self-nanoemulsifying concentrate with apple juice; first stage˜dilution with a warm (about 40° C.) filtered apple juice in a ratio of concentrate to beverage 1:8, second stage—further dilution of the obtained mixture with a non-filtered apple juice at room temperature in a ratio 1:100 (final ratio of 1:800).

FIG. 7 presents particle size distribution resulted after two stages dilution of the self-nanoemulsifying concentrate with beer; first stage—dilution with a warm (about 45° C.) filtered degassed beer in a ratio of concentrate to beverage 1:10, second stage—further dilution of the obtained mixture with a cold (+5° C.) beer at room temperature in a ratio 1:60 (final ratio of 1:600).

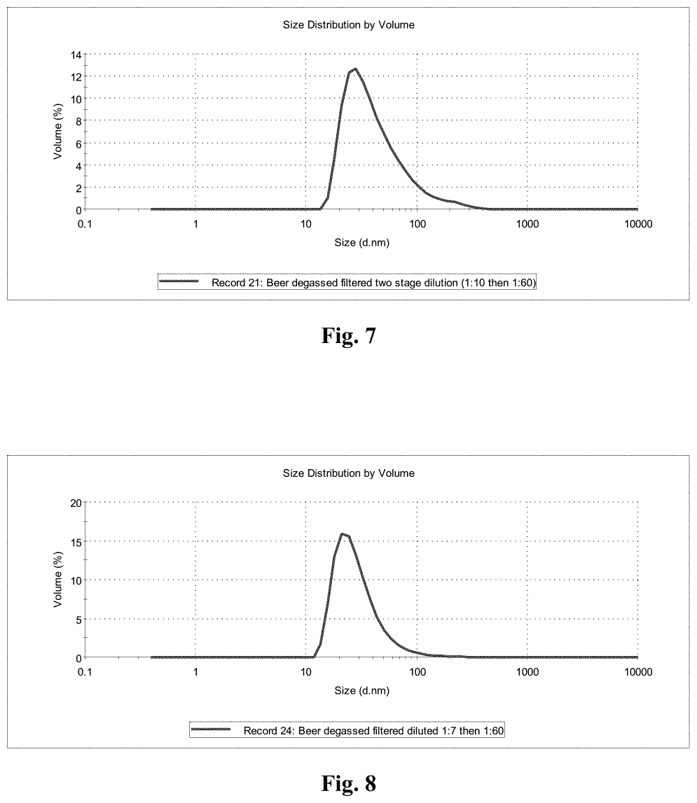

FIG. 8 presents particle size distribution resulted after two stages dilution of the self-nanoemulsifying concentrate with beer; first stage—dilution with a warm (about 45° C.) filtered degassed beer in a ratio of concentrate to beverage 1:7, second stage—further dilution of the obtained mixture with a non-filtered beer at room temperature in a ratio 1:60 (final ratio of 1:320).

The embodiments described herein are intended to be merely exemplary. Persons skilled in the art will understand that variations and modifications may be made without departing from the scope of the invention encompassed by the claims below.

We claim:

1. A method for preparing an alcoholic or non-alcoholic carbonated or non-carbonated beverage comprising at least one cannabis component, wherein the method comprises the steps of:
(a) diluting a SNEDS concentrate of at least one cannabis component with a liquid in ratio of liquid to concentrate from about 1:1 to about 100:1 by volume to form a pre-diluted mixture, and
(b) combining the pre-diluted mixture with an amount of a beverage thus forming a cannabinoid composition.

2. The method of claim 1, wherein the cannabis component is selected from the group consisting of cannabinoids, cannabis extract, individual biologically active components of cannabis and mixture thereof.

3. The method of claim 1, wherein the liquid is a beverage, water or a water-containing liquid.

4. A method for preparing an alcoholic or non-alcoholic carbonated or non-carbonated beverage comprising at least one cannabis component selected from the group consisting of cannabinoids, cannabis extract, individual biologically active components of cannabis and mixture thereof by consequent two-steps dilution of a self-nanoemulsifying concentrate,
wherein the concentrate comprises at least one physiologically acceptable aromatic compound for solubilization of the cannabis components, and
wherein the concentrate spontaneously forms oil-in-water nanoemulsion upon dilution.

5. The method of claim 4, wherein the concentrate is first diluted by addition of a beverage, water or a water-containing liquid to the concentrate in ratio of beverage, water or water-containing liquid to concentrate from about 1:1 to about 100:1 by volume to form a pre-diluted mixture, followed by further dilution of the pre-diluted mixture by addition of the pre-diluted mixture to a beverage, water or a water-containing liquid in a ratio of the pre-diluted mixture to the beverage, water or a water-containing liquid from about 1:5 to about 1:1000 by volume.

6. The method of claim 5, wherein the dilution are carried out at temperatures from about 0° C. to about 100° C.

7. The method of claim 4, wherein a portion of the beverage, water or a water-containing liquid used for first stage dilution is degassed and filtered through membrane filter with pore sizes from about 0.1 to about 5.0 mcm.

8. A method of claim 4, wherein:
(a) the at least one cannabis component is completely dissolved in the concentrate;
(b) the concentrate comprises at least one physiologically acceptable aromatic compound forming an oil phase wherein the at least one cannabis component remains completely dissolved in the oil phase after formation of the oil-in-water nanoemulsion; said aromatic compound comprises from about 10% to about 100% of the oil phase;
(c) the concentrate comprises at least one physiologically acceptable surfactant or mixture of surfactants; and
(d) the concentrate optionally comprises solubilized cannabis terpenes, physiologically acceptable essential oils or mixture thereof.

9. The concentrate of claim 8, wherein said physiologically acceptable aromatic compound is selected from the group consisting of liposoluble vitamins E, tocols, tocotrienols, tocopherols or tocopherol esters, anisole, anethole, esters of benzyl or phenethyl alcohol; esters of benzoic and salicylic acid.

10. The concentrate of claim 8, further optionally comprising a hydrophobic component selected from the group consisting of edible mono-, di-or triglycerides, acetylated mono- and diglycerides, fatty acids, fatty acids esters, aromatic and aliphatic esters, edible essential oils, and a mixture thereof.

11. The concentrate of claim 10, further optionally comprising at least one physiologically acceptable phospholipid, co-surfactant, water miscible co-solvent, solubilizer, flavor, flavor enhancers, antioxidant, preservative, colorant, sweetener and a mixture thereof.

12. A beverage prepared by dilution of the concentrate of claim 5 wherein the concentrate spontaneously forms a submicron oil-in-water emulsion.

13. The beverage of claim 12, wherein said oil-in-water emulsion comprises droplets with average size between about 5 nm to about 200 nm.

14. The self-nanoemulsifying concentrate of claim 4, wherein the concentrate comprises physiologically acceptable surfactant or mixture of surfactants, selected from the group of polyethoxylated tocopheryl succinate esters, polyethoxylated castor oil esters, polyethoxylated sorbitan esters, PEG esters of fatty acids, polyglyceryl fatty acid esters, fatty acid esters of saccharides, acyl glycosides, phospholipids, anionic surfactants and mixture thereof.

15. The concentrate of claim 14, wherein said phospholipids are selected from the group consisting of lecithin, phosphatidylcholine, phosphatidylethanolamine, phosphatidylinositol, phosphatidylserine, lysophosphatides, phosphatidic acids and salts thereof, enzyme treated lecithins and phosphatidylglycerol derivatives.
